(19) United States
(12) Patent Application Publication
(10) Pub. No.: US 2014/0244219 A1
(43) Pub. Date: Aug. 28, 2014

(54) METHOD OF CREATING A PIPE ROUTE LINE FROM A POINT CLOUD IN THREE-DIMENSIONAL MODELING SOFTWARE

(71) Applicant: AUTODESK, INC., San Rafael, CA (US)

(72) Inventors: Murali Pappoppula, Singapore (SG); Karthik Nathan, Singapore (SG)

(73) Assignee: AUTODESK, INC., San Rafael, CA (US)

(21) Appl. No.: 14/183,125

(22) Filed: Feb. 18, 2014

Related U.S. Application Data
(60) Provisional application No. 61/770,942, filed on Feb. 28, 2013.

(51) Int. Cl. G06F 17/50

(52) U.S. Cl. CPC G06F 17/5004
USPC 703/1

(57) ABSTRACT

A method, apparatus, system, article of manufacture, and computer program product provide the ability to create a pipe route. A point cloud is obtained into a three-dimensional (3D) modeling application. Cylinders in the point cloud are identified and added as solids overlaying the point cloud. All cylinders that make up the pipe route are identified by system aided selection of two or more of the solids. Automatically, and without additional user input, the selected solids are converted into objects. A continuous pipe route is constructed from the objects.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/770,942, filed on Feb. 28, 2013, by Murali Pappoppula and Karthik Nathan, entitled “METHOD OF CREATING A PIPE ROUTE LINE FROM A POINT CLOUD IN THREE-DIMENSIONAL MODELING SOFTWARE,” attorneys' docket number 30566.500-US-P1.

### BACKGROUND OF THE INVENTION

1. Field of the Invention

The present invention relates generally to piping and three-dimensional (3D) models, and in particular, to a method, apparatus, and article of manufacture for defining a pipe route line from point cloud data in 3D modeling software.

2. Description of the Related Art

There is lot of retrofit work being done on brownfield plant projects (e.g., abandoned or underused industrial and commercial facilities available for re-use), where part of a plant needs maintenance or part replacement and many times without any existing documents or 3D models.

One of the required work-flows by piping designers is to bring in part of the as-built existing plant into a 3D modeling software as quickly as possible, so that they can make changes & additions to the existing plant.

Creating intelligent plant models from a point cloud with minimal manual intervention is currently a big challenge. Point clouds represent the surfaces of real-world pipe routes, and thus contain their imperfections as well. Real-world pipes are also not perfectly aligned in space either (for e.g., they are not perfectly orthogonal, nor coplanar with their adjacent pipes, and they sag). Geometries extracted from such point clouds are therefore not precise enough for them to be converted into a connected 3D pipe route.

In view of the above, it may be noted that some prior art products may attempt to create intelligent 3D pipe routes from a point cloud. However, such solutions require multiple, tedious human interaction and manual correction/alignment of disconnected centerlines of extracted primitives. Such a workflow defeats the purpose of making it easy for the user to re-create an existing pipe route, as the process is very manual and time consuming.

Further, in the prior art, extracted centerlines of cylinders can only be corrected/aligned with adjacent centerlines, usually two at a time. This means that for a complex set of disconnected cylinders/centerlines, many such time consuming corrections/alignments will be needed.

In view of the above, what is needed is a method that allows the auto-correction of any number of complex, disconnected centerlines to create a continuous pipe route (i.e., all as part of a single selection and auto-correction process).

### SUMMARY OF THE INVENTION

A powerful workflow is enabled where the user has the ability to define a pipe route by only identifying key segments of imprecise extracted geometry, and embodiments of the invention will create the entire pipe route that is fully connected and aligned with the original point cloud.

The user input in the workflow is reduced to a minimum where the user only has to identify the extracted components from the point cloud that makes up the pipe route. The user can do this in a few ways: (a) System suggests possible pipe routes, which it calculates based on geometric validity and proximity; (b) User specifies all the end points of the pipe route and the system automatically creates a selection set of extracted geometries; and/or (c) User specifies segments for the selection set. Extracted geometries from the selection set of any complexity are automatically corrected and aligned with each other by inferring the existence of bends, tees, and crosses to form a continuous, intelligent pipe route of the appropriate size (e.g., length and diameter).

Embodiments of the invention remove the need for the tedious task of the user specifying accurate geometric information needed for reconstruction of intelligent 3D pipe routes from a point cloud.

Pipe routes typically consist of pipes, elbows, tees, and related components. When geometric primitives are extracted from point clouds of a pipe route, they largely consist of cylinders and tori. The centerlines of these extracted cylinders and tori are not connected and are not aligned with each other, which makes the derivation of a continuous pipe route from this a big challenge.

Through the use of the application of geometric and logical constraints (e.g., for coplanar, coincident, angle constraints, etc.) and the definition of piping rules, embodiments of the invention provide the ability to automatically derive a connected pipe route that closely aligns with the point cloud.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIGS. 3A and 3B illustrate the problem with deriving a piping route in accordance with one or more embodiments of the invention;

FIG. 4 illustrates the logical flow for deriving a connected pipe route in accordance with one or more embodiments of the invention;

FIG. 5 illustrates a graphical user interface for performing the first two steps of FIG. 4 in accordance with one or more embodiments of the invention;

FIG. 6 illustrates a graphical user interface for performing the third step of FIG. 4 in accordance with one or more embodiments of the invention;

FIG. 7 illustrates a graphical user interface for performing the fourth step of FIG. 4 in accordance with one or more embodiments of the invention;

FIG. 8 illustrates a dialog box for overriding a scale in accordance with one or more embodiments of the invention;

FIG. 9 illustrates a selection of a point cloud in accordance with one or more embodiments of the invention;

FIG. 10 illustrates the selection of cylinders option in accordance with one or more embodiments of the invention; and

FIG. 11 illustrates a selection of previously generated pipe route and a new set of cylinders to join in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Prior art solutions can only detect cylinders in a point cloud but don't offer the user any way to derive a continuous, intelligent pipe route line from them because the cylinders are disconnected and do not align. Instead, the prior art requires the user to manually correct and connect up two adjacent cylinders at a time. This is a very time-consuming and tedious process for just one real world pipe route line.

Embodiments of the invention propose a simple yet powerful workflow where the user can go from a point cloud to deriving a continuous pipe route line in an extremely short amount of time. Embodiments of the invention provide such capability by auto-correcting a complex set of disconnected centerlines in one action, instead of just two adjacent centerlines at a time.

### Hardware Environment

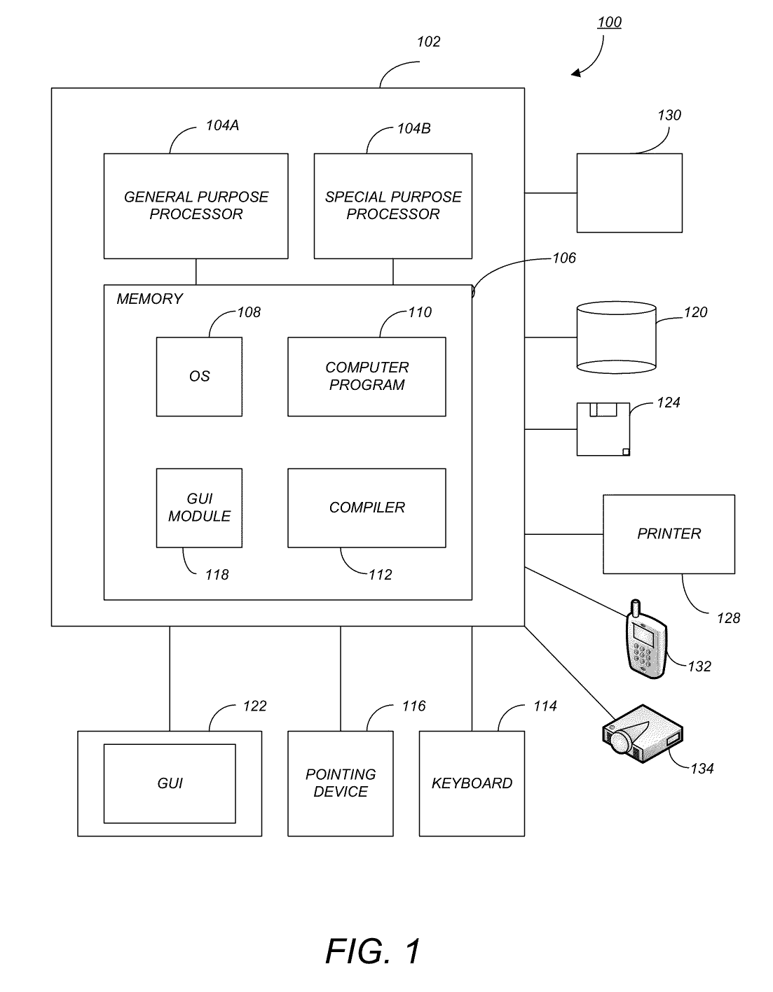

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one or more embodiments, computer 102 is communicatively coupled to, or may comprise, a laser scanner 134. Such a laser scanner 134 may consist of a field measurement device capable of producing a 3D representation of present conditions through the collection of individually measured points. The set of all points collected and registered with another after the scanning process is referred to as a point cloud. Such a point cloud may be stored in data storage devices 120/124, within the scanner 134, in memory 106, and/or in any other device capable of storing such information. The laser scanner 134 may utilize a variety of scanning methods including aerial, static, and mobile. Such laser scanning may scan millions of point in seconds without climbing on equipment and/or conducting contact measurements.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106, data storage device 120/124 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

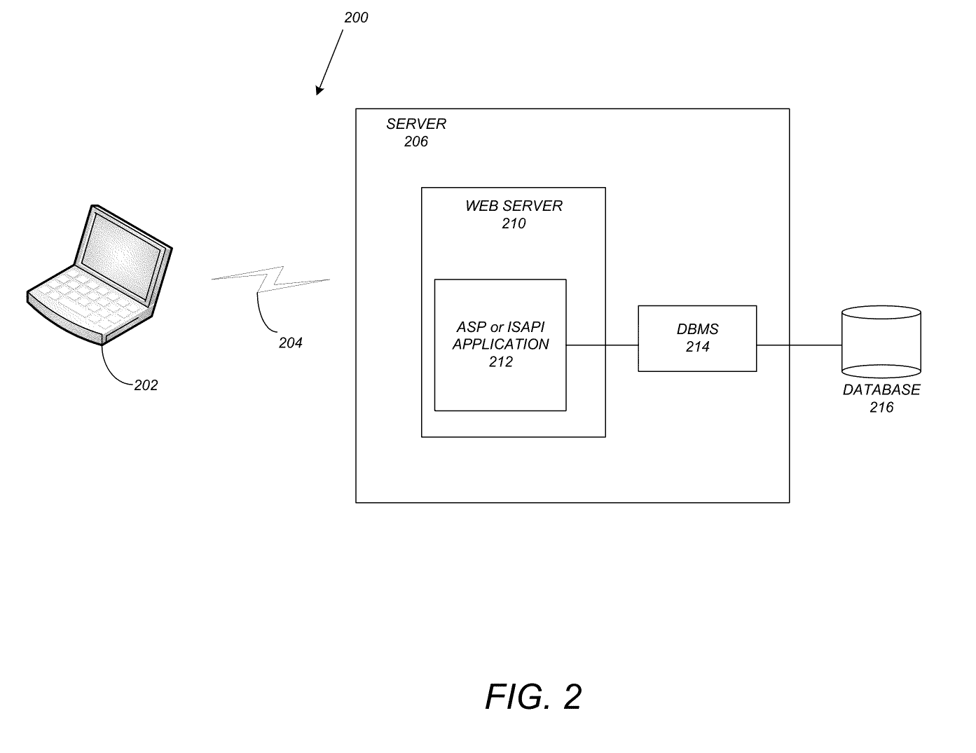

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### Software Embodiment Overview

As described above, work may be performed on brownfield plants. One of the required workflows on such a plant is to bring part of the as-built existing plant into 3D modeling software as quickly as possible. Embodiments of the invention utilize a software application on a client 202 or server computer 206 to perform such an integration. More specifically, a software application may be configured to utilize the laser scanner 134 to scan and register scanned points in a point cloud. The point cloud is then processed to generate the model (e.g., orthographic and/or isometric). As described above, as part of the model generation process (with respect to a piping system), the first step is to detect geometric primitives (e.g., cylinders/tori) that includes centerlines and diameters. From the centerlines, a routing line (for each geometric primitive) may be derived. However, each centerline may not match the other in real world conditions (i.e., the axis are non-coplanar).

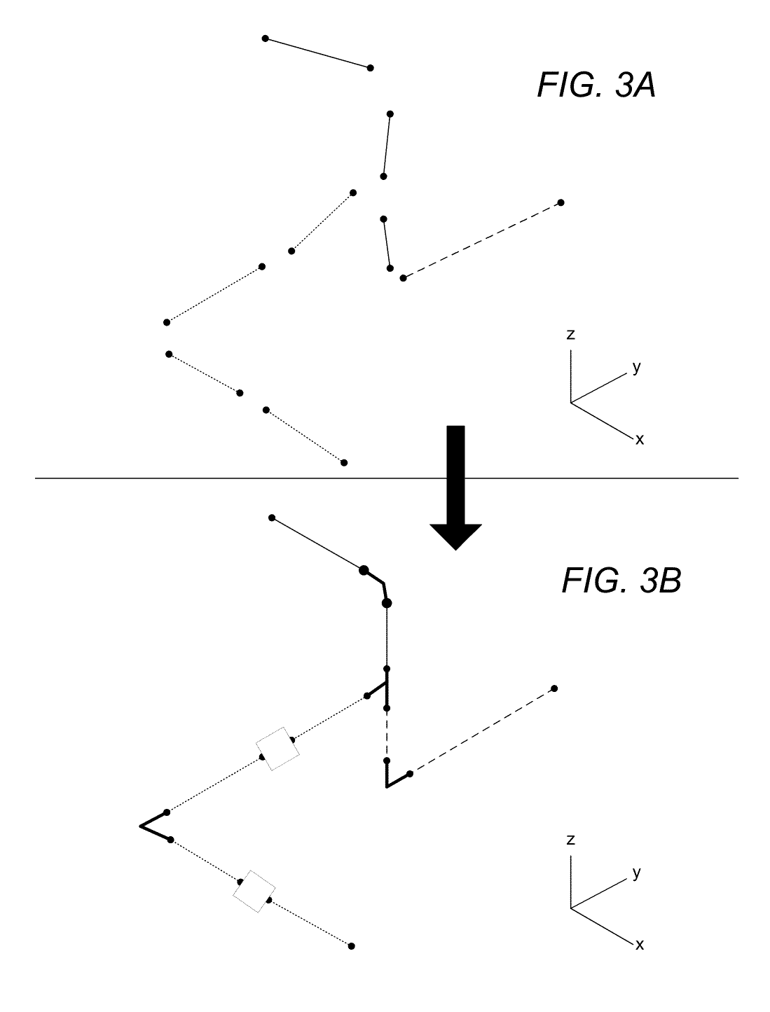

FIGS. 3A and 3B illustrate the problem with deriving a piping route. FIG. 3A illustrates the centerlines from geometric primitives recognized from a point cloud. As illustrated, the routing lines are non-coplanar and don't line up properly. However, plant design software and other modeling application require perfect geometry and topology. Accordingly, the routing lines of FIG. 3A must be optimized and corrected to result in the routing lines of FIG. 3B. What is needed is a user interface that allows routing of pipes aided by the centerlines extracted from an underlying point cloud as reference geometry.

Embodiments of the invention enable software that provides a powerful workflow where the user can define a pipe route by system aided selection tools to select key segments of the imprecise extracted geometry and create an entire pipe route that is fully connected and aligned with the original point cloud.

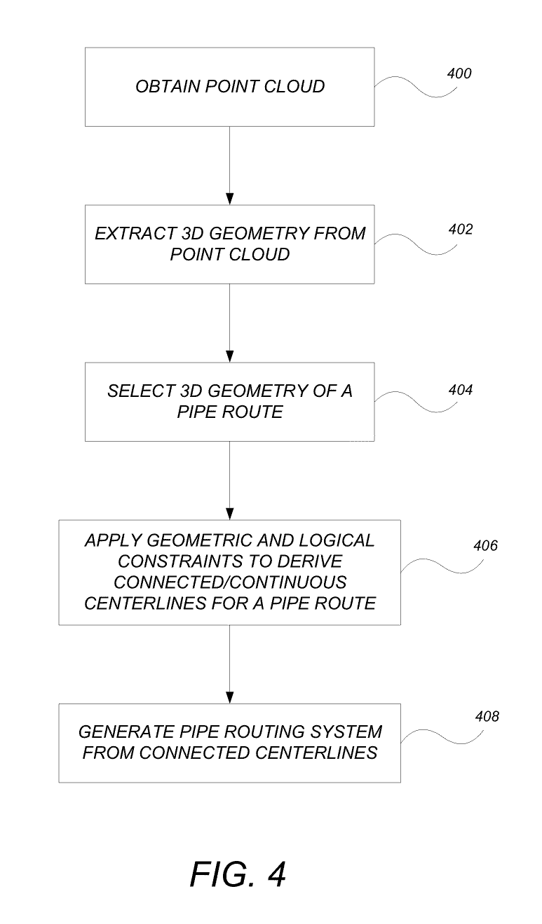

FIG. 4 illustrates the logical flow for deriving a connected pipe route in accordance with one or more embodiments of the invention. At step 400, the point cloud is obtained (e.g., from laser scanner 134).

At step 402, 3D geometry is extracted from the point cloud. When 3D geometry/geometric primitives are extracted from point clouds of a pipe route, they largely consist of cylinders and tori. As described above, the centerlines of these extracted cylinders and tori are not connected and are not aligned with each other. In the prior art, any user intervention to fix the geometry will render the feature semi-automatic (e.g., only two segments can be joined at a single time in a manual time-consuming manner).

At step 404, the user creates a selection set of the 3D geometry/geometric primitives that are to be part of a pipe route. Such a selection set likely includes more than two segments. This selection set can be created in a number of different ways: (a) System suggests possible pipe routes, which it calculates based on geometric validity and proximity; (b) User specifies all of the end points of the pipe route and the system automatically creates a selection set of extracted geometries; and/or (c) User specifies segments for the selection set. In other words, the user identifies all of the geometric primitives that will be part of a pipe route.

At step 406, geometric and logical constraints (and/or piping rules) are applied to derive the connected/continuous pipe route/centerlines from the selected/identified geometric primitives. Such constraints may consist of coplanar, coincident, angle-based constraints. In other words, based on the centerlines of FIG. 3A, the constraints are applied to derive a continuous and aligned set of centerlines that comprise the foundation for a single pipe route such as that in FIG. 3B. The constraints serve to intelligently connect the centerlines and “fix” their angles and make them coplanar if they weren't, thus creating a continuous polyline. Thus, the constraints are configured to perform at least two actions: (1) connect the gaps between cylinders/centerlines; and (2) make the cylinders/centerlines coplanar and correct the angles wherever possible. Such constraints may be controlled/managed by a constraint manager that is used to intelligently constrain the disconnected polylines (e.g., coincident, angle, parallel constraints) and solve the constrained model to get a nicely connected polyline.

At step 408, the continuous pipe route is used to generate a pipe routing system in the model. Such a process can be applied on individual pipe routes or on a set of pipe routes for batch conversion.

### Exemplary Workflows

Various workflows may be used to illustrate the process of deriving the connected pipe route in accordance with one or more embodiments of the invention.

Workflow 1

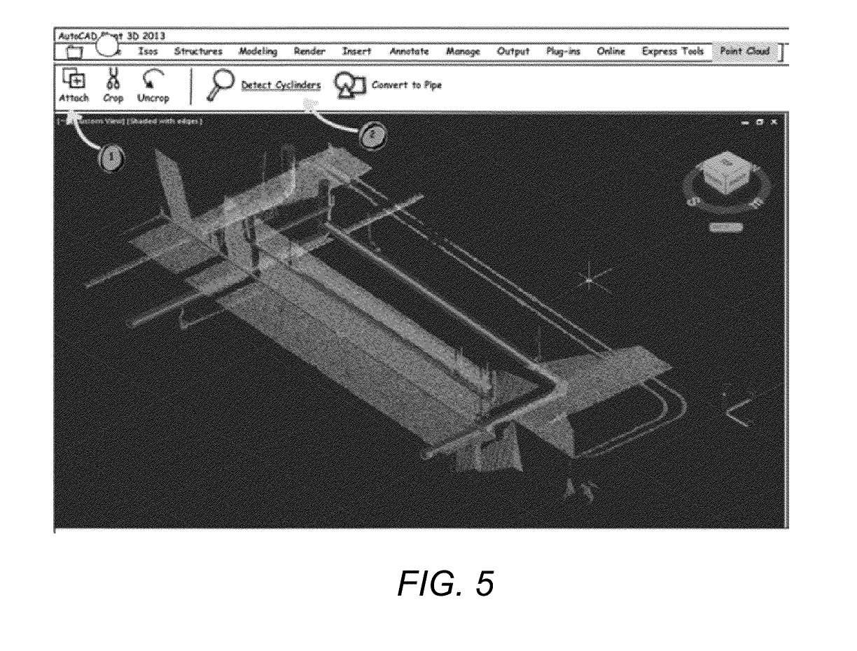

FIG. 5 illustrates two steps in an exemplary workflow for deriving a connected pipe route in accordance with one or more embodiments of the invention. At a first step, the user loads/attaches a section of a plant point cloud that the user wants to remodel into a computer-aided design (CAD) model (e.g., Plant 3D™). In a second step, upon invocation of a command (e.g., a “detect cylinders” command), all possible cylinders are identified and added as solids overlaying the point cloud (with increased transparency) for easier visualization.

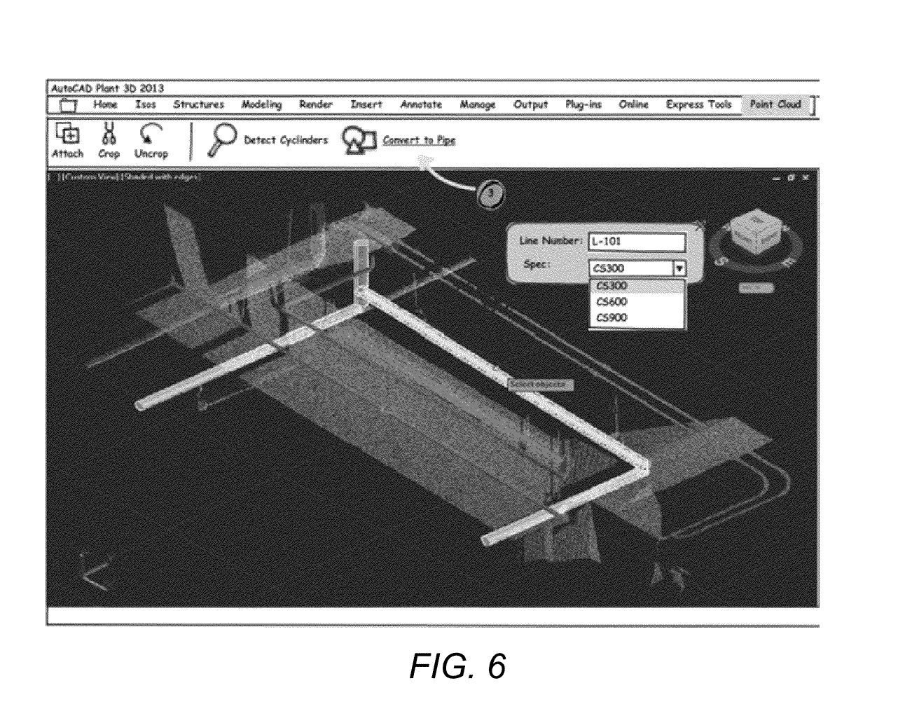

At step 3 (illustrated in FIG. 6), the user is then prompted (via a convert to pipe selection) to select a spec and line-number and to identify all cylinders making up that pipe-line.

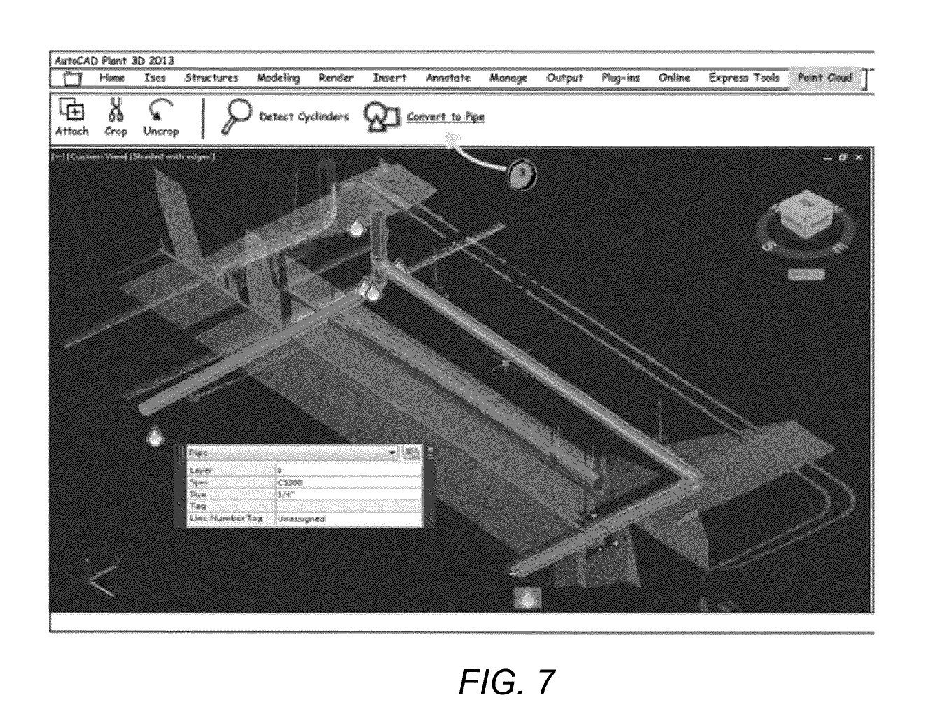

At step 4 (illustrated in FIG. 7), the selected solids are then automatically converted to objects (e.g., pipes, elbows, and tees). Such a conversion may be achieved by making use of the center line and radius information obtained using Feature Extraction application program interfaces (FE APIs). FE APIs provide a standard method for extracting geometric primitives and shapes from point clouds. The closest nominal diameter pipe from a selected specification will be chosen for pipe size.

Thereafter, embodiments of the invention may create the entire pipe-line and add appropriate reducers to handle pipes with varied diameters in the selected pipe-run.

Further, the user may also be presented with a list of narrowed down choices (based on spec and size) to identify any unidentified shapes within the pipe-line (e.g., valves, instruments, etc.). The reducers in the pipe-line may be calculated and deduced automatically (or via input from the user).

Additionally, the pipe-line may be completed for any part of the point cloud that failed to recognize such a part as a cylinder.

The above process may then be repeated for all pipe-lines in that section of the point cloud.

Workflow 2

In a second workflow, in a first step, a user loads a section of a point cloud that the user wants to re-model in a CAD application.

At a second step, the user may want to further isolate only a particular pipe-line that the user wants to re-model. In other words, the user may select and hide the rest of the point cloud (but for the pipe the user desires to isolate).

In a third step, the user sets the spec and starts routing the pipe tracing over the point cloud of the pipe-line.

In a fourth step, the size is automatically detected and the pipe auto snaps to the point cloud (specifically the vertices of the line point cloud).

In a fifth step, the user is prompted with a very specific list to insert all unidentified objects in the point cloud (e.g., valves, instruments, etc.). Embodiments of the invention may also attempt to calculate and deduce placement of reducers based on connected pipe size. Alternatively, the user may be provided with a list to select from.

In a sixth step, the first five steps may be repeated for all pipe-lines in the selected section of the point cloud.

### Design

Embodiments of the invention may be implemented via a point cloud pipe routing plug-in to a CAD based system (e.g., in unmanaged C++ ARX [AutoCAD™ Runtime Extension, which are essentially AutoCAD™ plugins]). Various components may be needed as part of the plug-in. A description of each of the components follows.

Cylinder Detection Command

One component of the plug-in is a command to detect all cylinders in either a selected portion of the point cloud or the entire visible portion of the point cloud. A crop/un-crop command from existing FE arx may be re-used. Detected cylinders may be displayed in a visually distinguishable manner (e.g., red or some other color that is not fixed). The point cloud may be made as transparent as possible once cylinders have been detected (e.g., 90).

Cylinder Selection Command

A second component is a command to select cylinders to make part of a pipe-line. A user may be prompted for a line-number and a pre-existing spec. Further, as cylinders are selected (by the user), the appearance may change to differentiate selected cylinders from other cylinders (e.g., the color, highlighting, bold, lighting, flashing, etc.). The system can also automatically detect possible pipe routes and present options to the user.

Continuous Polyline Construction Methodology

A third component is that of a methodology to construct a continuous polyline from the centerline of all selected cylinders. Such a component/methodology may include one or more of the following steps: (1) detecting extrapolated intersections of the centerlines; and (2) tagging cylinders (or centerlines) with diameter information (to be able to auto-insert the correct reducers).

When constructing a continuous spline from a set of disconnected centerlines (of cylinders), a vertex graph of all extrapolated intersections of centerlines may be built followed by a removal of any vertices (to combine edges that are not completely parallel but parallel within a tolerance).

As part of the above steps, the following constraints/properties may be considered/followed: (1) lines must be extrapolated to grid intersections; (2) lines must be made orthogonal if within a certain angle tolerance; (3) lines must be translated if needed to force intersections (tolerance issues); (4) lines in between, if too small, must be removed (for a given diameter, there is a minimum length otherwise elbows won't fit); and (5) extrapolated intersections are not considered real intersections if the lines are too far.

In addition to the above, “collinear” lines may be combined to create “filler” lines in between (only within a tolerance). Further, lines may be extended to unbounded lines to detect intersections with other lines (which may be optimized). Also, only intersections within a tolerance may be added.

In an auto-constrain model, various steps may also be followed. For example, coincident constraints, length constraints, angle constraints (e.g., 180 degrees and 90 degrees is possible), and parallel constraints (to orthogonal axes) may be applied. Such constraints may be based on the following equation:

|\vec{a}∥\vec{b}| cos θ=\vec{a}·\vec{b} [symbol] aₓbₓ+a_{y}b_{y}+a_{z}b_{z}=|\vec{a}∥\vec{b}| cos θ

Command to Use Polyline

A fourth component is that of a command to use the newly constructed polyline (e.g., line-number and spec information) to call an API (e.g., from PLANT 3D) to route a pipe. Such a command may automatically insert reducers using the diameter information. Further, corresponding cylinders may be deleted.

### Logical Flow

Creating an intelligent pipe route from a laser scan point cloud may involve the steps of attaching a point cloud followed by the extraction of the pipe route from the point cloud.

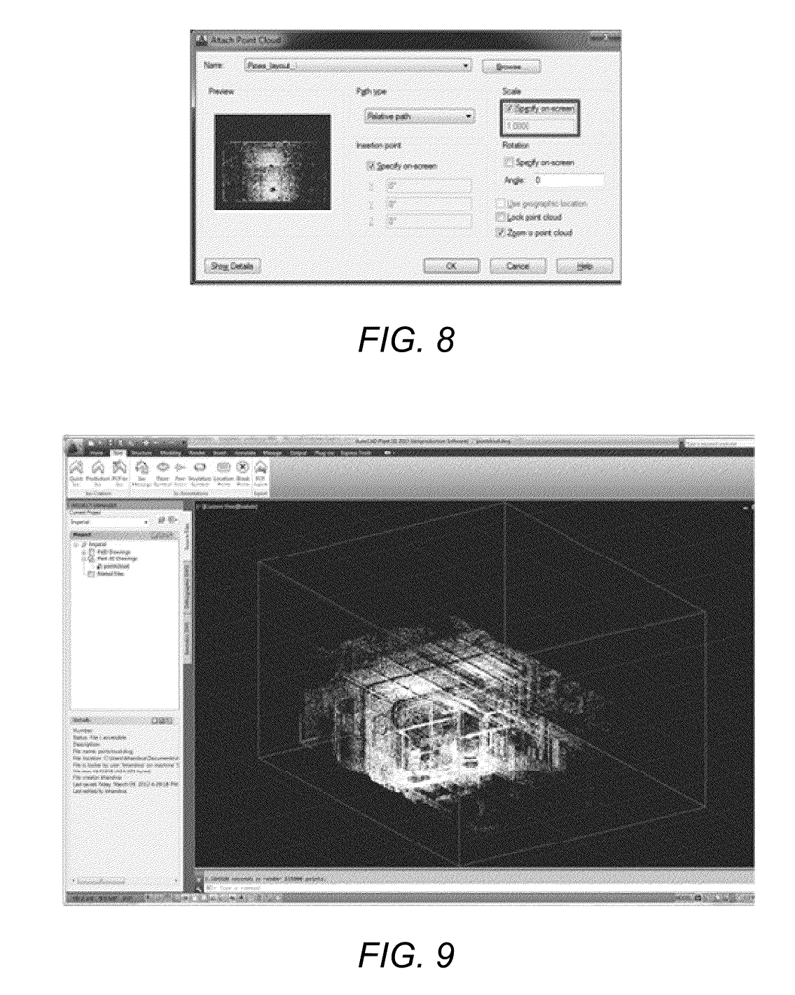

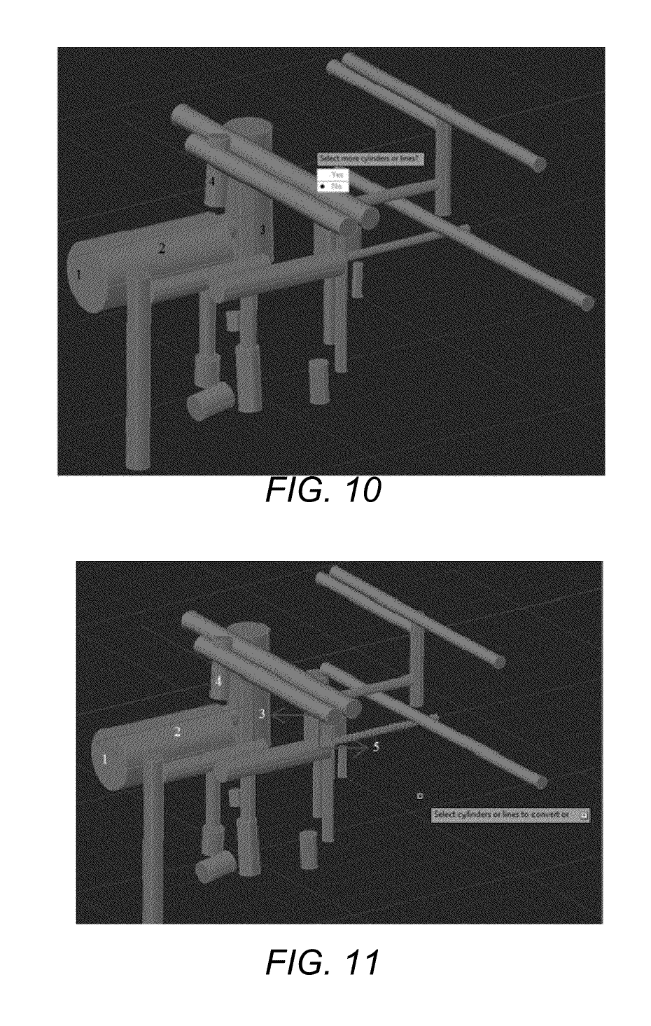

The point cloud attaching step includes creating a new drawing in a project having the same units as a point cloud file. Thereafter, a “POINTCLOUDATTACH” command (e.g., via an API) may be utilized to attach the point cloud file. When attaching, the user may have the option to override the scale by entering a new scale in a dialog box (as illustrated in FIG. 8) or by selecting a “specify on-screen” option (e.g., as illustrated in FIG. 8) and providing a value when prompted.

To extract the pipe route from the point cloud, embodiments of the invention may invoke a command (that can be hidden) (e.g., “PLANTPOINTCLOUDTOPIPES” API command) and type “all” to select the complete point cloud dataset (as illustrated in FIG. 9) or by specifying corner points and selecting a region.

Once the extraction command has been invoked, a feature extraction engine may detect the primitives (cylinders). All detected cylinders may be displayed in a visually distinguishable manner (e.g., a different color such as green).

The user may then be prompted with the following options: (1) to set the line number; (2) spec; or (3) select cylinders. FIG. 10 illustrates the selection of cylinders option in accordance with one or more embodiments of the invention. The user selects the cylinders that constitute a pipe route (the route may or may not be specified in the exact order).

The different created pipe routes may be displayed in different colors (e.g., one pipe route in purple and another in green) and may be converted into intelligent objects (e.g., PLANT3D OBJECTS).

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method for creating a pipe route, comprising:
obtaining a point cloud into a three-dimensional (3D) modeling application;
identifying cylinders in the point cloud;
adding the cylinders as solids overlaying the point cloud;
identifying all cylinders that make up the pipe route by system aided selection of two or more of the solids;
automatically, and without additional user input, converting the selected solids to objects; and
constructing a continuous pipe route from the objects.

2. The method of claim 1, wherein the obtaining the point cloud comprises selecting a portion of the point cloud.

3. The method of claim 1, wherein the converting comprises:
utilizing a centerline and radius information of the selected solids to identify objects to convert the selected solids into; and
selecting a closest diameter pipe from a specification as a size for the selected pipes in the pipe route.

4. The method of claim 1, wherein the cylinders identified in the point cloud are displayed in a different color from the point cloud color.

5. The method of claim 1, wherein as the two or more solids are selected, a color of each selected solid is changed to differentiate the selected solid from unselected solids.

6. The method of claim 1, wherein the constructing comprises:
detecting extrapolated intersections of centerlines of the cylinders;
tagging the centerlines with diameter information;
connecting the centerlines to create a continuous polyline; and
converting the continuous polyline into intelligent pipe routes with pipes, reducers, tees, elbows, and crosses automatically inserted.

7. The method of claim 6, wherein the constructing comprises:
utilizing one or more constraints to connect the centerlines of the cylinders.

8. The method of claim 7, wherein the constraints comprise geometric and logical constraints.

9. A computer readable storage medium encoded with computer program instructions which when accessed by a computer cause the computer to load the program instructions to a memory therein creating a special purpose data structure causing the computer to operate as a specially programmed computer, executing a method of creating a pipe route, comprising:
obtaining, in the specially programmed computer, a point cloud into a three-dimensional (3D) modeling application;
identifying, in the specially programmed computer, cylinders in the point cloud;
adding, in the specially programmed computer, the cylinders as solids overlaying the point cloud;
identifying, in the specially programmed computer, all cylinders that make up the pipe route by system aided selection of two or more of the solids;
automatically, and without additional user input, converting, in the specially programmed computer, the selected solids to objects; and
constructing, in the specially programmed computer, a continuous pipe route from the objects.

10. The computer readable storage medium of claim 9, wherein the obtaining the point cloud comprises selecting a portion of the point cloud.

11. The computer readable storage medium of claim 9, wherein the converting comprises:
utilizing a centerline and radius information of the selected solids to identify objects to convert the selected solids into; and
selecting a closest diameter pipe from a specification as a size for the selected pipes in the pipe route.

12. The computer readable storage medium of claim 9, wherein the cylinders identified in the point cloud are displayed in a different color from the point cloud color.

13. The computer readable storage medium of claim 9, wherein as the two or more solids are selected, a color of each selected solid is changed to differentiate the selected solid from unselected solids.

14. The computer readable storage medium of claim 9, wherein the constructing comprises:
detecting extrapolated intersections of centerlines of the cylinders;
tagging the centerlines with diameter information;
connecting the centerlines to create a continuous polyline; and
converting the continuous polyline into intelligent pipe routes with pipes, reducers, tees, elbows, and crosses automatically inserted.

15. The computer readable storage medium of claim 14, wherein the constructing comprises:
utilizing one or more constraints to connect the centerlines of the cylinders.

16. The computer readable storage medium of claim 15, wherein the constraints comprise geometric and logical constraints.
